(19) United States
(12) Patent Application Publication
(10) Pub. No.: US 2025/0089085 A1
(43) Pub. Date: Mar. 13, 2025

(54) USER EQUIPMENT, BASE STATION, AND WIRELESS COMMUNICATION METHOD

(71) Applicant: TCL COMMUNICATION (NINGBO) CO., LTD., Ningbo, Zhejiang (CN)

(72) Inventors: Xiaoxue YIN, Ningbo, Zhejiang (CN); Jia SHENG, Ningbo, Zhejiang (CN)

(73) Assignee: TCL COMMUNICATION (NINGBO) CO., LTD., Ningbo, Zhejiang (CN)

(21) Appl. No.: 18/552,904

(22) PCT Filed: Apr. 1, 2021
(86) PCT No.: PCT/CN2021/085023

§ 371 Date: Sep. 28, 2023

(51) Int. Cl. H04W 72/566; H04L 1/1812; H04L 1/1829

(52) U.S. Cl. CPC H04W 72/569; H04L 1/1812; H04L 1/1854

(57) ABSTRACT

A wireless communication method performed by the UE includes being configured, by a base station, with an indication indicating an availability of a multiplexing between uplink transmissions with different priorities, wherein the UE is configured with a multiplexing enabling indication by a radio resource control (RRC) parameter, and performing the multiplexing between the uplink transmissions with different priorities according to the indication, wherein the multiplexing between the uplink transmissions with different priorities comprises at least one of the followings: a multiplexing between PUCCHs or a multiplexing between a PUCCH and a PUSCH, wherein if the UE performs the multiplexing between the uplink transmissions with different priorities, the multiplexed uplink transmission is regarded as high priority.

### BACKGROUND OF DISCLOSURE

### 1. Field of the Disclosure

The present disclosure relates to the field of wireless communication systems, and more particularly, to a user equipment (UE), a base station, and wireless communication methods, which provide intra-UE multiplexing and prioritization enhancements for ultra-reliable low latency communication (URLLC)/industrial internet of things (IIOT), where intra-UE multiplexing and prioritization enhancements are one of work items in Release 17 of 3rd generation partnership project (3GPP).

### 2. Description of the Related Art

Wireless communication systems are widely deployed to provide various types of communication content such as voice, video, packet data, messaging, broadcast, and so on. These wireless communication systems may be capable of supporting communication with multiple users by sharing available system resources (e.g., time, frequency, and power). Examples of such multiple-access systems include fourth generation (4G) systems such as long term evolution (LTE) systems and fifth generation (5G) systems which may be referred to as new radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipments (UEs). A wireless communication network may include a base station that can support communication for a UE. The UE may communicate with the base station via downlink (DL) and uplink (UL). The DL refers to a communication link from the base station to the UE, and the UL refers to a communication link from the UE to the base station.

In previous releases of 3GPP, uplink transmission conflicts within a UE are discussed. However, a triggering method for multiplexing between uplink transmissions with different priorities and a physical uplink control channel (PUCCH) resource determination after the multiplexing are still not concluded. Besides, a discussion about channel state information (CSI) related multiplexing is relatively small and has not been concluded yet. The above open issues are important and need to be resolved.

Therefore, there is a need for a user equipment (UE), a base station, and wireless communication methods, which can solve issues in the prior art, provide intra-UE multiplexing and prioritization enhancements for ultra-reliable low latency communication (URLLC)/industrial internet of things (IIOT), guarantee a reliability and latency requirement of a high priority transmission, improve a transmit performance of a low priority transmission, and/or provide a good communication performance.

### SUMMARY

An object of the present disclosure is to propose a user equipment (UE), a base station, and a wireless communication method, which can solve issues in the prior art, provide intra-UE multiplexing and prioritization enhancements for ultra-reliable low latency communication (URLLC)/industrial internet of things (IIOT), guarantee a reliability and latency requirement of a high priority transmission, improve a transmit performance of a low priority transmission, and/or provide a good communication performance.

In a first aspect of the present disclosure, a wireless communication method performed by a user equipment (UE) comprises being configured, by a base station, with an indication indicating an availability of a multiplexing between uplink transmissions with different priorities and performing the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the UE performs the multiplexing between the uplink transmissions with different priorities, the multiplexed uplink transmission is regarded as high priority.

In a second aspect of the present disclosure, a wireless communication method performed by a base station comprises configuring, to a user equipment (UE), an indication indicating an availability of a multiplexing between uplink transmissions with different priorities and controlling the UE to perform the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the base station controls the UE to perform the multiplexing between the uplink transmissions with different priorities, the multiplexed uplink transmission is regarded as high priority.

In a third aspect of the present disclosure, a user equipment (UE) comprises a memory, a transceiver, and a processor coupled to the memory and the transceiver. The processor is configured, by a base station, with an indication indicating an availability of a multiplexing between uplink transmissions with different priorities and the processor is configured to perform the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the processor performs the multiplexing between the uplink transmissions with different priorities, the multiplexed uplink transmission is regarded as high priority.

In a fourth aspect of the present disclosure, a base station comprises a memory, a transceiver, and a processor coupled to the memory and the transceiver. The processor is configured to configure, to a user equipment (UE), an indication indicating an availability of a multiplexing between uplink transmissions with different priorities and the processor is configured to control the UE to perform the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the processor controls the UE to perform the multiplexing between the uplink transmissions with different priorities, the multiplexed uplink transmission is regarded as high priority.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station (e.g., gNB) of communication in a communication network system according to an embodiment of the present disclosure.

FIG. 2 is a flowchart illustrating a wireless communication method performed by a user equipment (UE) according to an embodiment of the present disclosure.

FIG. 3 is a flowchart illustrating a wireless communication method performed by a base station according to an embodiment of the present disclosure.

FIG. 4 is a schematic diagram illustrating an example that an uplink transmission with low priority overlaps with uplink transmissions with high priority according to an embodiment of the present disclosure.

FIG. 5 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Ultra-reliable low latency communication (URLLC), is one of several different types of use cases supported by 5G new radio (NR) standard, for example, as stipulated by 3rd generation partnership project (3GPP) Release 15. URLLC is a communication service for successfully delivering packets with stringent requirements, particularly in terms of availability, latency, and reliability. URLLC can enable supporting emerging applications and services. Example services include wireless control and automation in industrial factory environments, inter-vehicular communications for improved safety and efficiency, and a tactile internet. It is important for 5G especially considering an effective support of verticals which brings new business to the whole telecommunication industry. One of key features of URLLC is the low latency. Low latency is important for gadgets that, say, drive themselves, or perform prostate surgeries. Low latency allows a network (such as a base station) to be optimized for processing incredibly large amounts of data with minimal delay (or latency). The network needs to adapt to a broad amount of changing data in real time. 5G can enable this service to function. URLLC can be, arguably, the most promising addition to upcoming 5G capabilities, but it will also be the hardest to secure. URLLC requires a quality of service (QoS) totally different from mobile broadband services. URLLC can provide the network with instantaneous and intelligent systems, though it will require transitioning out of a core network.

New URLLC wireless connectivity can guarantee latency to be 1 ms or less. In order for this interface to achieve low latency, all the devices have to synchronize to the same time-base. Time-sensitive networking is another component of 5G URLLC capabilities. This can allow shapers used for managing traffic to be time aware. The design of a low-latency and high-reliability service involves several components: Integrated frame structure, incredibly fast turnaround, efficient control and data resource sharing, grant-free based uplink transmission, and advanced channel coding schemes. Uplink grant-free structures guarantee a reduction in user equipment (UE) latency transmission through avoiding the middle-man process of acquiring a dedicated scheduling grant.

A current work item on enhanced industrial internet of things (IoT) and URLLC for release 17 has been disclosed in a meeting. The detailed objectives of the work item (WI) at least includes the followings:

Intra-UE multiplexing and prioritization of traffic with different priority based on work done in release 16 [RAN1]: a. Specify multiplexing behavior among hybrid automatic repeat request acknowledgment (HARQ-ACK)/scheduling request (SR)/channel state information (CSI) and physical uplink shared channel (PUSCH) for traffic with different priorities, including the cases with UCI on physical uplink control channel (PUCCH) and uplink control information (UCI) on PUSCH. b. Specify physical (PHY) prioritization of overlapping dynamic grant PUSCH and configured grant PUSCH of different PHY priorities on a bandwidth part (BWP) of a serving cell including the related cancelation behavior for the PUSCH of lower PHY priority, taking the solution developed during Rel-16 as the baseline.

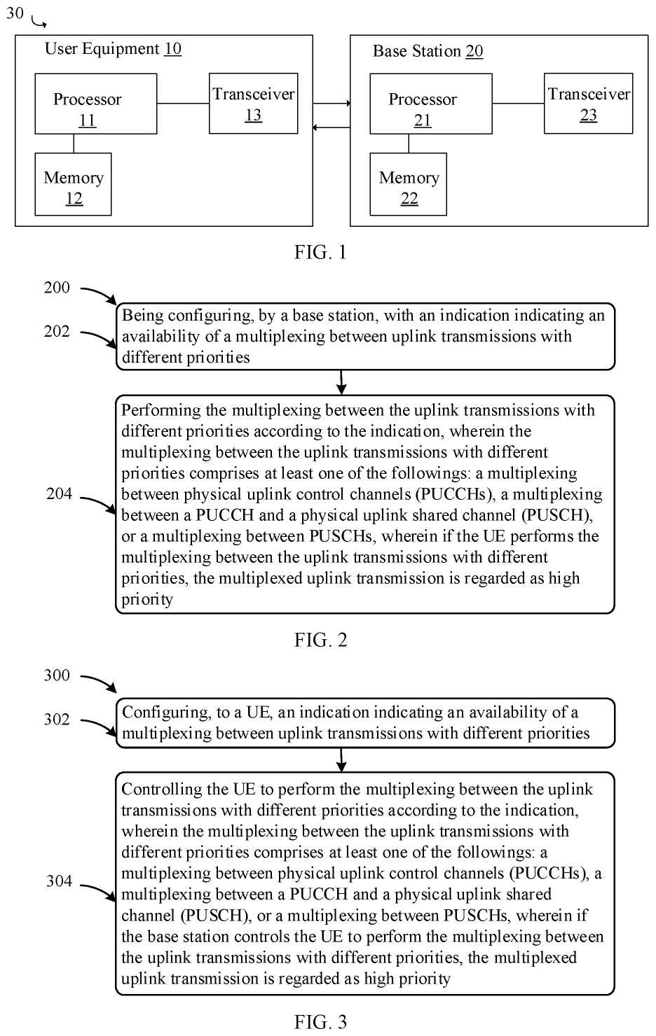

FIG. 1 illustrates that, in some embodiments, one or more user equipments (UEs) 10 and a base station (e.g., gNB) 20 for communication in a communication network system 30 according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured, by the base station 20, with an indication indicating an availability of a multiplexing between uplink transmissions with different priorities and the processor 11 is configured to perform the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the processor 11 performs the multiplexing between the uplink transmissions with different priorities, the multiplexed uplink transmission is regarded as high priority. This can solve issues in the prior art, provide intra-UE multiplexing and prioritization enhancements for ultra-reliable low latency communication (URLLC)/industrial internet of things (IIOT), guarantee a reliability and latency requirement of a high priority transmission, improve a transmit performance of a low priority transmission, and/or provide a good communication performance.

In some embodiments, the processor 21 is configured to configured, to the UE 10, an indication indicating an availability of a multiplexing between uplink transmissions with different priorities and the processor 21 is configured to control the UE 10 to perform the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the processor 21 controls the UE 10 to perform the multiplexing between the uplink transmissions with different priorities, the multiplexed uplink transmission is regarded as high priority. This can solve issues in the prior art, provide intra-UE multiplexing and prioritization enhancements for ultra-reliable low latency communication (URLLC)/industrial internet of things (IIOT), guarantee a reliability and latency requirement of a high priority transmission, improve a transmit performance of a low priority transmission, and/or provide a good communication performance.

FIG. 2 illustrates a wireless communication method 200 performed by a user equipment (UE) according to an embodiment of the present disclosure. In some embodiments, the method 200 includes: a block 202, being configured, by a base station, with an indication indicating an availability of a multiplexing between uplink transmissions with different priorities, and a block 204, performing the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the UE performs the multiplexing between the uplink transmissions with different priorities, the multiplexed uplink transmission is regarded as high priority. This can solve issues in the prior art, provide intra-UE multiplexing and prioritization enhancements for ultra-reliable low latency communication (URLLC)/industrial internet of things (IIOT), guarantee a reliability and latency requirement of a high priority transmission, improve a transmit performance of a low priority transmission, and/or provide a good communication performance.

FIG. 3 illustrates a wireless communication method 300 performed by a base station according to an embodiment of the present disclosure. In some embodiments, the method 300 includes: a block 302, configuring, to a UE, an indication indicating an availability of a multiplexing between uplink transmissions with different priorities, and a block 304, controlling the UE to perform the multiplexing between the uplink transmissions with different priorities according to the indication, wherein the multiplexing between the uplink transmissions with different priorities comprises at least one of the followings: a multiplexing between physical uplink control channels (PUCCHs), a multiplexing between a PUCCH and a physical uplink shared channel (PUSCH), or a multiplexing between PUSCHs, wherein if the base station controls the UE to perform the multiplexing between the uplink transmissions with different priorities, the multiplexed uplink transmission is regarded as high priority. This can solve issues in the prior art, provide intra-UE multiplexing and prioritization enhancements for ultra-reliable low latency communication (URLLC)/industrial internet of things (IIOT), guarantee a reliability and latency requirement of a high priority transmission, improve a transmit performance of a low priority transmission, and/or provide a good communication performance.

In some embodiments, the UE 10 is configured with a multiplexing enabling indication per uplink transmission by a radio resource control (RRC) parameter and/or a downlink control information (DCI) indication. In some embodiments, the UE 10 is configured with the multiplexing enabling indication according to a priority-level indication by the RRC parameter and/or the DCI indication. In some embodiments, the UE 10 is configured to enable and trigger the multiplexing between the uplink transmissions according to the RRC parameter or the DCI indication, or the UE 10 is configured to enable the multiplexing between the uplink transmissions according to the RRC parameter and the UE 10 is configured to trigger the multiplexing between the uplink transmissions according to the DCI indication.

Optionally, the base station 20 configures, to the UE 10, the multiplexing enabling indication by the RRC parameter. This provides advantages that there is no information misalignment between the base station 20 and the UE 10 because there is no downlink control information (DCI) miss detection issue. In some examples, some methods of configuring the multiplexing enabling indication by the RRC parameter are provided. Optionally, in a first example, a method is to configure the multiplexing enabling indication per PUCCH, which means the multiplexing enabling indication can be configured with other PUCCH related parameters. In the first example, the multiplexing enabling indication is configured for different PUCCH configurations, such that for different PUCCH groups, multiplexing enabling indications could be different. Optionally, an information element (IE), PUCCH-Config, is used to configure UE specific PUCCH parameters (per BWP) and the multiplexing enabling indication, MUXEnableInd, is used to enable a multiplexing function for uplink (UL) transmissions with different priorities. MUXEnableInd can be indicated by the IE, PUCCH-Config. This can be applied to a multiplexing between PUCCHs. Optionally, if MUXEnableInd is present, the multiplexing is enabled for UL transmissions with different priorities. Optionally, if MUXEnableInd is absent, the multiplexing for UL transmissions with different priorities is not supported.

In some examples, the multiplexing enabling indication can be indicated by another information element (IE) PUSCH-Config. This can be applied to a multiplexing between a PUCCH and a PUSCH or a multiplexing between PUSCHs. The IE PUSCH-Config is used to configure UE specific PUSCH parameters applicable to a particular BWP and MUXEnableInd is used to configure enabling the multiplexing function for UL transmissions with different priorities. MUXEnableInd can be indicated by IE PUSCH-Config. Optionally, if MUXEnableInd is present, the multiplexing is enabled for UL transmissions with different priorities. Optionally, if MUXEnableInd is absent, the multiplexing is not supported.

In a second example, a method is to configure the multiplexing enabling indication, MUXEnableInd, with a priority-level indication. In release 16, a 2-level priority indication is supported for different UCI types, and the 2-level priority indication is defined as phy-PriorityIndex configured in IE ConfiguredGrantConfig which is used to configure uplink transmission without dynamic grant according to two possible schemes. In the second example, the multiplexing enabling do not distinguish UCI types or PUCCH or PUSCH, and the multiplexing enabling could be applied to any uplink transmissions. Optionally, in order to save more signalling overhead, the multiplexing enabling indication is only indicated for UL transmission with higher priority. When the multiplexing is enabled for the high priority UL transmission, the multiplexing could be performed for UL transmissions with different priorities.

Optionally, the base station 20 configures, to the UE 10, the multiplexing enabling indication by the DCI indication. Configuring via the DCI indication reduces a delay in information transmission and is more targeted. Some embodiments propose to indicate the multiplexing enabling indication explicitly, which means a 1-bit parameter can be introduced and indicated by a DCI format. The scheduling mechanism could be the same as the RRC indication in the above embodiments. Optionally, the multiplexing enabling indication, MUXEnableInd, can be indicated by the DCI format. Optionally, if MUXEnableInd is present, the multiplexing is enabled for UL transmissions with different priorities. Optionally, if MUXEnableInd is absent, the multiplexing for UL transmissions with different priorities is not supported.

Optionally, the base station 20 configures, to the UE 10, the multiplexing enabling indication by the RRC parameter and the DCI indication. If the multiplexing enabling indication is indicated by the RRC parameter, all the related PUCCHs follow the multiplexing procedure. However, some of these transmissions may not sensitive to latency and do not need to increase multiplexing complexity to improve reliability of low priority uplink transmissions. Multiplexing can be performed selectively for the more essential transmissions. To this end, the multiplexing procedure could be enabled by the RRC parameter and triggered by the DCI format. That is to say, when the multiplexing enabling indication, MUXEnableInd, is indicated by the RRC parameter, the multiplexing function for UL transmission with different priorities is enabled but it doesn't mean the multiplexing is performed. The multiplexing is triggered by the DCI format, only if the multiplexing is triggered in the DCI format, the multiplexing is performed.

In some embodiments, the UE 10 performs the multiplexing between the uplink transmissions with different priorities if all overlapping uplink transmissions are configured with the multiplexing enable indication, or otherwise the multiplexing between the uplink transmissions with different priorities is not supported. In some embodiments, an uplink transmission with high priority is configured with the multiplexing enable indication. In some embodiments, if the UE 10 performs the multiplexing between the uplink transmissions with different priorities, the multiplexed uplink transmission is regarded as high priority.

For the above embodiments, there is one problem that if the multiplexing enabling indications are different for overlapping UL transmissions. Therefore, scheduling rules need to be specified. In a first exemplary solution, multiplexing for UL transmission with different priorities is performed only if all the overlapping UL transmissions are configured with the multiplexing enable indication, otherwise the multiplexing is not supported. In a second exemplary solution, the multiplexing enabling indication is only indicated for the UL transmission with high priority. Because the UL transmission with higher priority has more stringent requirement on reliability and latency, the multiplexing procedure should not influence the performance for higher priority transmission. To this end, only if the UL transmission with higher priority is indicated to enable the multiplexing procedure, the multiplexing is supported.

FIG. 4 illustrates an example that an uplink transmission with low priority overlaps with uplink transmissions with high priority according to an embodiment of the present disclosure. FIG. 4 illustrates that, there is overlapping between a PUCCH with low priority (LP PUCCH) and PUCCH1 with high priority (HP PUCCH1), and there is overlapping between the LP PUCCH and a HP PUCCH2. This example assumes that LP PUCCH and HP PUCCH1 meet a timeline condition to perform the multiplexing. This example provides some solutions to deal with the overlapping between multiplexed PUCCH and HP PUCCH2. The solutions solve a priority determination for the multiplexed PUCCH and the subsequent prioritization or multiplexing procedure. In details, a basic solution is to determine the priority after multiplexing to guarantee a performance for high priority transmissions. That is to say, as long as the uplink transmission of multiplexing contains a high-priority transmission, the multiplexed PUCCH after multiplexing is regarded as high priority transmission. For example, if the multiplexing is performed between two UL transmissions with different priorities, the multiplexed UL transmission is regarded as high priority. The following procedure can follow the existing mechanism.

Regarding the subsequent procedures, some embodiments provide two exemplary solutions. The first exemplary solution is to follow a chronological order to solve a collision scenario for more than 2 UL transmissions. The existing mechanism can be followed. For the example in FIG. 4, due to the chronological order, the UE 10 resolves the overlapping between the LP PUCCH and the HP PUCCH1, if the multiplexing timeline condition is met, the UE multiplexes the LP PUCCH and the HP PUCCH1, and the multiplexed PUCCH is regarded as high priority. Further, a collision handling between multiplexed PUCCH and HP PUCCH2 could follow the existing mechanism in Release 15 or other multiplexing mechanism for high priority transmissions. If the multiplexing condition is not met for the LP PUCCH and the HP PUCCH1, the LP PUCCH is dropped, and both HP PUCCH1 and HP PUCCH2 could be transmitted.

Regarding the subsequent procedures, the second exemplary solution is to guarantee a latency requirement for high priority transmission. Because if the multiplexing is performed for all the overlapping transmissions, the high priority transmission maybe delayed. To this end, the second exemplary solution is that if the low priority UL transmission overlaps with more than 2 UL transmissions at the same time, at least one of them is high priority, the low priority UL transmission is dropped. Take the example in FIG. 4, when the LP PUCCH overlaps with the HP PUCCH1 and the HP PUCCH2 at the same time, the LP PUCCH is dropped, and the HP PUCCH1 and HP PUCCH2 could be transmitted without overlapping.

The above embodiments can be summarized as: If an uplink transmission with low priority overlaps with uplink transmissions with high priority, the UE 10 follows a chronological order to process the overlapping between the uplink transmission with low priority and the uplink transmissions with high priority. If an uplink transmission with low priority overlaps with uplink transmissions with high priority, the UE 10 drops the uplink transmission with low priority and transmits the uplink transmissions with high priority.

The exemplary solutions introduced above could be applied for all types of UCIs. However, due to different PUCCH formats, handling solutions are different especially the PUCCH resource determination for the multiplexed PUCCH. Therefore, some exemplary collision handling methods for dedicated UCI types are provided as follows.

A first scenario is an exemplary collision handling between a PUCCH carrying a scheduling request (SR) with high priority and a PUCCH carrying a hybrid automatic repeat request acknowledgment (HARQ-ACK) with low priority. In some embodiments, if there is a collision between a PUCCH carrying a scheduling request (SR) with high priority and a PUCCH carrying a hybrid automatic repeat request acknowledgment (HARQ-ACK) with low priority, the UE 10 drops the HARO-ACK with low priority with a PUCCH format 2 or 3 or 4 if the SR with high priority is positive. In some embodiments, if there is a collision between a PUCCH carrying a SR with high priority and a PUCCH carrying a HARQ-ACK with low priority, the UE 10 drops the SR with high priority and transmits the HARQ-ACK with low priority on a PUCCH resource scheduling for the HARQ-ACK with low priority if the SR with high priority is negative. In some embodiments, if there is a collision between a PUCCH carrying a SR with high priority and a PUCCH carrying a HARQ-ACK with low priority PUCCH format 0 or 1, the UE 10 transmits the SR with high priority and the HARQ-ACK with low priority on a PUCCH resource scheduling for the HARQ-ACK with low priority if the SR with high priority is positive.

In details, it is understood that a HARQ feedback may be the most important among multiple UCI types. In multiple conflict scenarios, the HARQ feedback is also handled as a higher priority to ensure stability of HARQ transmission as much as possible. For PUCCH format 2, 3 and 4, more than 2 bits UCI are supported. In an example, if there exists collision between the HP SR and the LP HARQ, a PUCCH resource for SR transmission is not available for the multiplexed SR and HARQ. The following exemplary solutions are proposed. The first exemplary solution is to drop HARQ-ACK with PUCCH format 2 or 3 or 4 if the HP SR is positive. For the first exemplary solution, it leads to less specification impact and easier for UE implementation. Optionally, if the high priority SR is negative, the HP SR could be dropped, and the LP HARQ can be transmitted on the PUCCH resource determined for this LP HARQ. The second exemplary solution is to transmit the multiplexed PUCCH (the HP SR and the LP HARQ) on the PUCCH resource for the LP HARQ. Similar to the first exemplary solution, if the HP SR is positive, the multiplexing could be performed, and/or if the HP SR is negative, only the LP HARQ needs to be transmitted.

A second scenario is an exemplary collision handling between a PUCCH carrying a CSI with high priority with a PUCCH format 2, 3, or 4 and a PUCCH carrying a HARQ-ACK with low priority with a PUCCH format 0 or 1, the priority of UCI transmission is determined according to the service type (such as a priority of an actual PUCCH/PUSCH configuration) and regardless the UCI type. For example, the service type may be PUCCH/PUSCH carrying the CSI. For example, the UCI type may be PUCCH/PUSCH carrying the HARQ-ACK. In some embodiments, if there is a collision between a PUCCH carrying a channel state information (CSI) with low priority with a PUCCH format 2, 3, or 4 and a PUCCH carrying a HARQ-ACK with high priority with a PUCCH format 0 or 1, a priority for UCI transmission is determined according to the priority of the PUCCH carrying the CSI, such that the priority for UCI transmission is regarded as the low priority, the UE 10 drops the CSI with low priority with the PUCCH format 2, 3, or 4. In some embodiments, if there is a collision between a PUCCH carrying a CSI with high priority with a PUCCH format 2, 3, or 4 and a PUCCH carrying a HARQ-ACK with low priority with a PUCCH format 0 or 1, a priority for UCI transmission is determined according to the priority of the PUCCH carrying the CSI, such that the priority for UCI transmission is regarded as the high priority, the UE transmits the CSI with high priority with the PUCCH format 2, 3, or 4 on a PUCCH resource scheduling for the CSI with high priority with the PUCCH format 2, 3, or 4. In some embodiments, if there is a collision between a PUCCH carrying a CSI with high priority with a PUCCH format 2, 3, or 4 and a PUCCH carrying a HARQ-ACK with low priority with the PUCCH format 2, 3, or 4, a priority for UCI transmission is determined according to the priority of the PUCCH carrying the CSI, such that the priority for UCI transmission is regarded as the high priority, the UE transmits the CSI with high priority with the PUCCH format 2, 3, or 4 and the HARQ-ACK with low priority with the PUCCH format 2, 3, or 4 on a PUCCH resource scheduling for the CSI with high priority with the PUCCH format 2, 3, or 4. In some embodiments, if there is a collision between a PUCCH carrying a CSI with low priority with a PUCCH format 2, 3, or 4 and a PUCCH carrying a HARQ-ACK with high priority with the PUCCH format 2, 3, or 4, a priority for UCI transmission is determined according to the priority of the PUCCH carrying the CSI, such that the priority for UCI transmission is regarded as the low priority, the UE transmits the CSI with low priority with the PUCCH format 2, 3, or 4 and the HARQ-ACK with high priority with the PUCCH format 2, 3, or 4 on a PUCCH resource scheduling for the HARQ-ACK with high priority with the PUCCH format 2, 3, or 4.

According to the definition of the current 3GPP specification, periodic or semi-persistent CSI is processed as low priority. Some embodiments of the present disclosure propose to determine the priority of UCI transmission only considering the service type and regardless the UCI type. Therefore, some embodiments of the present disclosure propose to determine the priority of UCI transmission according to a priority of an actual PUCCH/PUSCH configuration. In some embodiments, in details, for CSI on PUCCH/PUSCH, if the PUCCH/PUSCH is configured with high priority and carrying the CSI, the priority of UCI transmission can be regarded as the high priority when a collision happens. In some embodiments, in details, for CSI on PUCCH/PUSCH, if the PUCCH/PUSCH is configured with low priority and carrying the CSI, the priority of UCI transmission can be regarded as the low priority when a collision happens. This could improve the high priority transmission. In a recent release, CSI transmission on PUCCH only PUCCH format 2, 3 and 4 are supported. Based on this, two scenarios need to be discussed in the following table 1.

TABLE 1

HARQ-ACK

| | | PUCCH | PUCCH |
|---|---|---|---|
| | | format 0 or 1 | format 2, 3, or 4 |
| CSI | PUCCH | Case 1 | Case 2 |
| | format 2, 3, or 4 | | |

For case 1, similar to the above embodiments, it is not available to transmit both CSI and HARQ-ACK on PUCCH format 0 or 1. In this example, if the CSI is low priority, the CSI is dropped, or if the latency is acceptable for the high priority transmission, the multiplexed UCI could be transmitted on the PUCCH resource scheduling for the CSI. On the contrary, if the CSI is high priority and HARQ-ACK is low priority, the multiplexed UCI could be transmitted on the PUCCH resource scheduling for the CSI.

For case 2, for both CSI and HARQ-ACK feedback, the PUCCH formats ar all corresponding to carry more than 2 bits UCI. To guarantee the reliability and latency requirement, the multiplexed UCI is transmitted on PUCCH resource configured for high priority transmission. Therefore, if the CSI is high priority and HARQ-ACK with low priority, the CSI and HARQ-ACK are transmitted on PUCCH resource scheduled for CSI transmission. On the contrary, if CSI is low priority and HARQ-ACK is high priority, the multiplexed UCI is transmitted on PUCCH resource scheduled for HARQ-ACK transmission.

It should be mentioned that, in release 17, aperiodic CSI transmitted on PUCCH is in discussion, if this mechanism is supported, the above solutions are all applicable for A-CSI on PUCCH.

Regarding the multiplexing between PUCCH and PUSCH, except for some special scenarios, the uplink transmission after the multiplexing can be transmitted on PUSCH, it is not available to transmit PUSCH conveying UL-SCH on PUCCH. And the PUSCH could be divided into two categories, PUSCH only conveying UL-SCH, and PUSCH conveying UL-SCH and HARQ-ACK and/or CSI and/or other UCI types.

An exemplary collision handling between high priority PUCCH and low priority PUSCH is provided. In some embodiments, if there is a collision between a PUCCH with high priority and a PUSCH only carrying an uplink shared channel (UL-SCH) with low priority, an uplink control information (UCI) transmitted on the PUCCH with high priority is transmitted on the PUSCH only carrying the UL-SCH with low priority if a latency is acceptable. In some embodiments, if there is a collision between a PUCCH with high priority and a PUSCH carrying a UL-SCH and a HARQ-ACK and/or a CSI and/or other UCI types with low priority, the UE drops the PUSCH with low priority and transmits the PUCCH with high priority. In some embodiments, if there is a collision between a PUCCH with high priority and a PUSCH carrying a UL-SCH and a HARQ-ACK and/or a CSI and/or other UCI types with low priority, the UE transmits a UCI with high priority on the PUSCH with low priority and drops a UCI with low priority transmitted on the PUSCH with low priority. In some embodiments, if there is a collision between a PUCCH with high priority and a PUSCH carrying a UL-SCH and a HARQ-ACK and/or a CSI and/or other UCI types with low priority, a UCI with high priority transmitted on the PUSCH with low priority is also transmitted on the PUCCH with high priority if available.

In details, for a first exemplary situation, if this low priority PUSCH only conveys UL-SCH, the UCI transmitted on high priority PUCCH can be transmitted on low priority PUSCH if the latency is acceptable. The condition to be satisfied is that the last symbol of the multiplexed PUSCH cannot be later than the last symbol of the original HP PUCCH transmission, or if it is later than the last symbol of the original HP PUCCH transmission, the offset between them should be acceptable and could not exceed the defined threshold. For the low priority PUSCH, it can be scheduled another beta-offset for the multiplexing with high priority UCI specifically. Optionally, the beta-offset values are defined for a UE to determine a number of resources for multiplexing UCI information in a PUSCH.

In details, for a second exemplary situation, the low priority PUSCH conveying UL-SCH and HARQ-ACK and/or CSI and/or other UCI types overlaps with high priority PUCCH. If the low priority PUSCH is available for transmit both high priority PUCCH and low priority PUSCH, the multiplexing procedure can follow the description in the first exemplary situation. If the low priority PUSCH is not sufficient for the full transmission, an enhancement is needed.

In some examples, a first exemplary solution is to drop the transmission of low priority PUSCH and transmit the high priority PUCCH only. The main advantage of this solution is the small spec impact and has no influence on the reliability and latency for the high priority transmission. However, at the same time, this could bring negative influence on the low priority transmission. To improve the performance for low priority transmission, a second exemplary solution is to transmit the high priority UCI on low priority PUSCH and drop the low priority UCI transmitted on PUSCH. That is to say, the HARQ and/or CSI and/or other UCI types transmitted on low priority PUSCH can be fully or partially pre-empted by the high priority UCI. As for the fully or partially pre-empted could be configured, it could be configured by higher layer parameters or DCI, or it could be the UE capability determined by each UE. If the partially pre-empted is selected, for the different UCI types, there can define a list for pre-emption priorities. For example, the CSI can be pre-empted firstly and then if the resource is still not sufficient HARQ-ACK should be pre-empted. And this pre-emption list could be configurable. On the other hand, for a third exemplary solution, the multiplexed UCI could also be transmitted on high priority PUCCH if available. And part of the UCI types transmitted on low priority PUSCH could be transmitted on high priority PUCCH. Similarly, different priority levels need to be defined for different UCI types, e.g., HARQ-ACK (transmitted in low priority PUSCH) is multiplexed with high priority PUCCH first, or if the high priority PUCCH resource is sufficient, HARQ-ACK and CSI could be both multiplexed with high priority PUCCH.

An exemplary collision handling between low priority PUCCH and high priority PUSCH is provided. In some embodiments, if there is a collision between a PUCCH with low priority and a PUSCH with high priority, the UE multiplexes and transmits the PUSCH with high priority on a resource. In some embodiments, if the PUCCH with low priority carries a HARQ-ACK and a CSI feedback, the UE multiplexes the HARQ-ACK with the PUSCH high priority if available. In some embodiments, if the PUCCH with low priority carries several bits of a HARQ-ACK with low priority and the PUSCH with high priority is not available to transmit a full version of the HARQ-ACK with low priority, the UE compresses the HARQ-ACK, and the UE multiplexes the compressed HARQ-ACK with the PUSCH with high priority. In some embodiments, the UE replies an ACK to the base station only when all HARQs carried by the PUCCH with low priority are ACKs.

In details, regarding the overlapping between low priority PUCCH and high priority PUSCH, the principle is the same as the above embodiments. If the low priority PUCCH and high priority PUSCH meet the multiplexing condition, it can be multiplexed and transmitted on the resource for high priority PUSCH. Similarly, for the high priority PUSCH, it can be scheduled another beta-offset for the multiplexing with low priority UCI specifically. In addition, if the PUSCH resource for high priority is not sufficient for the transmission of both high priority PUSCH and low priority PUCCH, an enhancement solution is required. To improve the transmission efficiency and the reliability of low priority UL transmission, partially or compressed transmission can be supported. For example, if the low priority PUCCH is carrying HARQ-ACK and CSI feedback, at least HARQ-ACK could be multiplexed with high priority PUSCH if available. Furthermore, if the low priority PUCCH carries several bits of HARQ-ACK and the high priority PUSCH is not available to transmit the full version of the low priority HARQ-ACK, the compressed HARQ-ACK could be transmitted. Optionally, if a low-priority HARQ is dropped or replied as NACK, the base station 20 will perform the operation of retransmission for the corresponding transmission. Therefore, if the low priority HARQ is a NACK, there is no need to transmit with the high priority PUSCH, in particular if the resource is not sufficient. Optionally, if all the HARQ-ACKs are ACK and send to the base station successfully, this can save a series of retransmission operations. Therefore, it can be specified that an ACK is replied to the base station 20 only when all the HARQs carried by the conflicting low-priority PUCCH are ACKs. And then send this 1-bit ACK with high priority if available. To distinguish it from the high priority UCIs carried in the PUSCH, the values of beta-offset can be different for different priority levels.

An exemplary collision handling between PUSCHs is provided. In some embodiments, if there is a collision between a PUSCH only carrying a UL-SCH with high priority and a PUSCH only carrying a UL-SCH with low priority, the UE drops the PUSCH only carrying the UL-SCH with low priority. In some embodiments, if there is a collision between a PUSCH only carrying a UL-SCH with high priority and a PUSCH carrying a UL-SCH and a HARQ-ACK and/or a CSI and/or other UCI types with low priority, the UL-SCH and the HARQ-ACK and/or the CSI and/or the UCI types transmitted in the PUSCH with low priority can be transmitted in the PUSCH with high priority if available. In some embodiments, if there is a collision between a PUSCH carrying a UL-SCH and a HARQ-ACK and/or a CSI and/or other UCI types with high priority and a PUSCH only carrying a UL-SCH with low priority, the UE drops the PUSCH only carrying the UL-SCH with low priority. In some embodiments, if there is a collision between a PUSCH carrying a UL-SCH and a HARQ-ACK and/or a CSI and/or other UCI types with high priority and a PUSCH carrying a UL-SCH and a HARQ-ACK and/or a CSI and/or other UCI types with low priority, the UL-SCH and the HARQ-ACK and/or the CSI and/or the UCI types transmitted in the PUSCH with low priority can be transmitted in the PUSCH with high priority if available.

In details, regarding the collision scenario between PUSCHs with different priorities, as specified in Table 2, collision cases between different priorities, the following 4 cases are discussed.

TABLE 2

| | | Low priority PUSCH | |
|---|---|---|---|
| | | | Conveying UL-SCH and |
| | | Only | a HARQ-ACK and/or a |
| | | conveying | CSI and/or other UCI |
| | | UL-SCH | types |
| High | Only conveying UL-SCH | Case 1 | Case 2 |
| priority | Conveying UL-SCH and | Case 3 | Case 4 |
| PUSCH | a HARQ-ACK and/or a | | |
| | CSI and/or other UCI | | |
| | types | | |

In some examples, for case 1 and case 3, the low priority PUSCH only conveys UL-SCH, multiplexing is not available. Therefore, the low priority PUSCH is dropped.

In some examples, for case 2 and case 4, high priority PUSCH only conveys UL-SCH and the low priority PUSCH conveying UL-SCH and a HARQ-ACK and/or a CSI and/or other UCI types, the HARQ-ACK and/or the CSI and/or other UCI types transmitted in low priority PUSCH could be transmitted in high priority PUSCH if available. The detailed solution could follow the mechanism the above embodiments.

In summary, the exemplary solutions above could be specifically used for URLLC and/or eMBB and/or any other traffic type, and any combinations of the solutions above could be possible. Some embodiments of the present disclosure provide several multiplexing solutions for different scenarios, including collision handling between PUCCHs, between PUSCHs, and between PUCCH and PUSCH with different priorities. Further, some embodiments provide the indication mechanism for enabling the multiplexing function and the resource determination for the transmission after multiplexing for each scenario. In addition, some embodiments also provide subsequent solutions for some specific scenario. The proposed solutions could both guarantee the reliability and latency requirement of high priority transmission and improve the transmit performance of low priority transmission. The scheme in some embodiments ensures minimal impact on high-priority transmissions while improving the reliability of low-priority transmissions.

Commercial interests for some embodiments are as follows. 1. Solving issues in the prior art. 2. Providing intra-UE multiplexing and prioritization enhancements for ultra-reliable low latency communication (URLLC)/industrial internet of things (IIOT). 3. Guaranteeing a reliability and latency requirement of a high priority transmission. 4. Improving a transmit performance of a low priority transmission. 5. Providing a good communication performance. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure propose technical mechanisms.

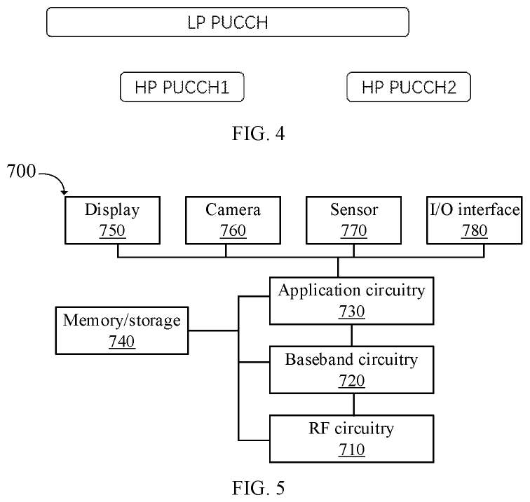

FIG. 5 is a block diagram of an example system 700 for wireless communication according to an embodiment of the present disclosure. Embodiments described herein may be implemented into the system using any suitably configured hardware and/or software. FIG. 5 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The first positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method performed by a user equipment (UE), comprising:
being configured, by a base station, with an indication indicating an availability of a multiplexing between uplink transmissions with different priorities, wherein the UE is configured with a multiplexing enabling indication by a radio resource control (RRC) parameter; and
performing the multiplexing between the uplink transmissions with different priorities according to the indication, wherein the multiplexing between the uplink transmissions with different priorities comprises at least one of the followings: a multiplexing between physical uplink control channels (PUCCHs) or a multiplexing between a PUCCH and a physical uplink shared channel (PUSCH), wherein if the UE performs the multiplexing between the uplink transmissions with different priorities, the multiplexed uplink transmission is regarded as high priority.

2. (canceled)

3. The wireless communication method of claim 1, wherein the UE is configured with the multiplexing enabling indication according to a priority-level indication by the RRC parameter.

4. The wireless communication method of claim 3, wherein the UE is configured to enable and trigger the multiplexing between the uplink transmissions according to the RRC parameter.

5. The wireless communication method of claim 1, wherein the UE performs the multiplexing between the uplink transmissions with different priorities if all overlapping uplink transmissions are configured with the multiplexing enable indication, or otherwise the multiplexing between the uplink transmissions with different priorities is not supported.

6. The wireless communication method of claim 3, wherein an uplink transmission with high priority is configured with the multiplexing enable indication.

7. The wireless communication method of claim 1, wherein if an uplink transmission with low priority overlaps with uplink transmissions with high priority, the UE follows a chronological order to process the overlapping between the uplink transmission with low priority and the uplink transmissions with high priority.

8. The wireless communication method of claim 1, wherein if an uplink transmission with low priority overlaps with uplink transmissions with high priority, the UE drops the uplink transmission with low priority and transmits the uplink transmissions with high priority.

9. The wireless communication method of claim 1, wherein if there is a collision between a PUCCH carrying a scheduling request (SR) with high priority and a PUCCH carrying a hybrid automatic repeat request acknowledgment (HARQ-ACK) with low priority, the UE drops the HARO-ACK with low priority with a PUCCH format 2 or 3 or 4 if the SR with high priority is positive.

10. The wireless communication method of claim 1, wherein if there is a collision between a PUCCH carrying a SR with high priority and a PUCCH carrying a HARQ-ACK with low priority, the UE drops the SR with high priority and transmits the HARQ-ACK with low priority on a PUCCH resource scheduling for the HARQ-ACK with low priority if the SR with high priority is negative.

11-15. (canceled)

16. The wireless communication method of claim 1, wherein if there is a collision between a PUCCH with high priority and a PUSCH only carrying an uplink shared channel (UL-SCH) and/or uplink control information (UCI) types with low priority, the UE multiplexes the UCI transmitted on PUCCH with high priority in PUSCH with low priority.

17-19. (canceled)

20. The wireless communication method of claim 1, wherein if there is a collision between a PUCCH with low priority and a PUSCH with high priority, the UE multiplexes and transmits the PUSCH with high priority on a resource.

21. The wireless communication method of claim 20, wherein if the PUCCH with low priority carries a HARQ-ACK and a CSI feedback, the UE multiplexes the HARQ-ACK with the PUSCH of high priority if available.

22-27. (canceled)

28. A wireless communication method performed by a base station, comprising:
configuring, to a user equipment (UE), an indication indicating an availability of a multiplexing between uplink transmissions with different priorities, wherein the base station configures, to the UE, a multiplexing enabling indication by a radio resource control (RRC) parameter; and
controlling the UE to perform the multiplexing between the uplink transmissions with different priorities according to the indication, wherein the multiplexing between the uplink transmissions with different priorities comprises at least one of the followings: a multiplexing between physical uplink control channels (PUCCHs) or a multiplexing between a PUCCH and a physical uplink shared channel (PUSCH), wherein if the base station controls the UE to perform the multiplexing between the uplink transmissions with different priorities, the multiplexed uplink transmission is regarded as high priority.

29-42. (canceled)

43. The wireless communication method of claim 28, wherein if there is a collision between a PUCCH with high priority and a PUSCH only carrying an uplink shared channel (UL-SCH) and/or uplink control information (UCI) types with low priority, the base station controls the UE to multiplex the UCI transmitted on PUCCH with high priority in PUSCH with low priority.

44-46. (Not entered)

47. The wireless communication method of claim 28, wherein if there is a collision between a PUCCH with low priority and a PUSCH with high priority, the base station controls the UE to multiplex and transmit the PUSCH with high priority on a resource.

48. The wireless communication method of claim 47, wherein if the PUCCH with low priority carries a HARQ-ACK and a CSI feedback, the base station controls the UE to multiplex the HARQ-ACK with the PUSCH of high priority if available.

49-54. (canceled)

55. A user equipment (UE), comprising:
a memory;
a transceiver; and
a processor coupled to the memory and the transceiver;
wherein the processor is configured by a base station, with an indication indicating an availability of a multiplexing between uplink transmissions with different priorities, wherein the processor is configured with a multiplexing enabling indication by a radio resource control (RRC) parameter; and
wherein the processor is configured to perform the multiplexing between the uplink transmissions with different priorities according to the indication, wherein the multiplexing between the uplink transmissions with different priorities comprises at least one of the followings: a multiplexing between physical uplink control channels (PUCCHs) or a multiplexing between a PUCCH and a physical uplink shared channel (PUSCH), wherein if the processor performs the multiplexing between the uplink transmissions with different priorities, the multiplexed uplink transmission is regarded as high priority.

56-61. (canceled)

62. The UE of claim 55, wherein if there is a collision between a PUCCH with high priority and a PUSCH only carrying an uplink shared channel (UL-SCH) and/or uplink control information (UCI) types with low priority, the UE multiplexes the UCI transmitted on PUCCH with high priority in PUSCH with low priority.

63. The UE of claim 55, wherein if there is a collision between a PUCCH with low priority and a PUSCH with high priority, the UE multiplexes and transmits the PUSCH with high priority on a resource.

64. The UE of claim 55, wherein if the PUCCH with low priority carries a HARQ-ACK and a CSI feedback, the UE multiplexes the HARQ-ACK with the PUSCH of high priority if available.
